(19) United States
(12) Patent Application Publication
(10) Pub. No.: US 2019/0182458 A1
(43) Pub. Date: Jun. 13, 2019

(54) IMAGING DEVICE AND IMAGING SYSTEM

(71) Applicant: CANON KABUSHIKI KAISHA, Tokyo (JP)

(72) Inventor: Fujio Kawano, Kawasaki-shi (JP)

(21) Appl. No.: 16/205,819

(22) Filed: Nov. 30, 2018

(30) Foreign Application Priority Data
Dec. 8, 2017 (JP) 2017-236393

(51) Int. Cl. H04N 9/04; H04N 9/77; H04N 5/235; H04N 5/265; G06T 7/90; G06T 7/55

(52) U.S. Cl. CPC H04N 9/0451; H04N 9/77; H04N 5/2355; H04N 5/265; H04N 5/2351; B60W 30/09; G06T 7/55; G06T 2207/30252; G06T 2207/10028; G06T 2207/10024; G06T 7/90

(57) ABSTRACT

An imaging device includes an imaging element including first pixels, each of which outputs a signal including color information, and second pixels having a higher sensitivity than the first pixels, and a signal processing unit that processes signals from the imaging element and includes a luminance value acquisition unit that acquires luminance values of the first pixels based on signals from the second pixels and a color acquisition unit that acquires color ratios from color and luminance values of the first pixels and acquires, from the color ratios, color components of each of the first and second pixels. The color acquisition unit acquires the color ratio by using color values in the first pixels acquired in a first capturing condition and luminance values in the first pixels based on signals of the second pixels acquired in a second capturing condition of a lower sensitivity than the first capturing condition.

### BACKGROUND OF THE INVENTION

### Field of the Invention

The present invention relates to an imaging device and an imaging system.

### Description of the Related Art

In a single-plate type imaging element, color filters (CF) through which specific wavelength components, for example, lights of respective colors of red (R), green (G), and blue (B) pass are arranged in a particular pattern on pixels in order to obtain a color image. As a CF pattern, those having a so-called Bayer arrangement are widely used. Further, in addition to a CF of RGB, there is a growing use of a CF of an RGBW arrangement that includes W pixels having a filter that transmits light in the entire wavelength range of visible light.

While an imaging element having a CF of RGBW arrangement can improve sensitivity by using W pixels and acquire an image of a high S/N ratio, W pixels are easily saturated compared to the RGB pixels that are color pixels, which makes capturing under a high brightness environment difficult. This means that saturation is likely to occur even in the capturing condition with the same light amount and results in a narrow dynamic range, and this is a common issue in achieving higher sensitivity by using detection of a non-spectral signal or a wide-wavelength range component signal.

Japanese Patent Application Laid-Open No. 2017-055330 discloses a method of performing multiple times of exposure operations and readout operations within one frame to reduce occurrence of output saturation in W pixels in a solid state imaging device having a CF with an RGBW arrangement.

However, there is a demand for further expanding the dynamic range while ensuring color reproducibility in order to obtain a higher quality image.

### SUMMARY OF THE INVENTION

The present invention intends to provide an imaging device and an imaging system that can acquire a good quality image with a wide dynamic range and a high color reproducibility.

According to one aspect of the present invention, there is provided an imaging device including an imaging element including a plurality of pixels that includes a plurality of first pixels, each of which outputs a signal including color information on any of a plurality of colors, and a plurality of second pixels having a higher sensitivity than the first pixels, and a signal processing unit that processes signals output from the imaging element, wherein the signal processing unit includes a luminance value acquisition unit that acquires luminance values of the first pixels based on signals output from the second pixels, and a color acquisition unit that acquires color ratios of the plurality of colors in a predetermined unit region from color values and the luminance values of the first pixels and acquires, from the acquired color ratios, color components of each of the first pixels and each of the second pixels included in the unit region, and wherein the color acquisition unit acquires each of the color ratios by using color values in the first pixels acquired in a first capturing condition and luminance values in the first pixels based on signals of the second pixels acquired in a second capturing condition of a lower sensitivity than the first capturing condition.

According to another aspect of the present invention, there is provided a signal processing device that processes signals output from an imaging element including a plurality of pixels that include a plurality of first pixels, each of which outputs a signal including color information on any of a plurality of colors, and a plurality of second pixels having a higher sensitivity than the first pixels, the signal processing device including a luminance value acquisition unit that acquires luminance values of the first pixels based on signals output from the second pixels, and a color acquisition unit that acquires color ratios of the plurality of colors in a predetermined unit region from color values and the luminance values of the first pixels and acquires, from the acquired color ratios, color components of each of the first pixels and each of the second pixels included in the unit region, wherein the color acquisition unit acquires each of the color ratios by using color values in the first pixels acquired in a first capturing condition and luminance values in the first pixels based on signals of the second pixels acquired in a second capturing condition of a lower sensitivity than the first capturing condition.

According to yet another aspect of the present invention, there is provided an imaging system including an imaging device including an imaging element including a plurality of pixels that include plurality of first pixels, each of which outputs a signal including color information on any of a plurality of colors, and a plurality of second pixels having a higher sensitivity than the first pixels, and a signal processing unit that processes signals output from the imaging device, wherein the signal processing unit includes a luminance value acquisition unit that acquires luminance values of the first pixels based on signals output from the second pixels, and a color acquisition unit that acquires color ratios of the plurality of colors in a predetermined unit region from color values and the luminance values of the first pixels and acquires, from the acquired color ratios, color components of each of the first pixels and each of the second pixels included in the unit region, and wherein the color acquisition unit acquires each of the color ratios by using color values in the first pixels acquired in a first capturing condition and luminance values in the first pixels based on signals of the second pixels acquired in a second capturing condition of a lower sensitivity than the first capturing condition.

Further features of the present invention will become apparent from the following description of exemplary embodiments with reference to the attached drawings.

### BRIEF DESCRIPTION OF THE DRAWINGS

FIG. 1 is a block diagram illustrating a general configuration of an imaging device according to a first embodiment of the present invention.

FIG. 2 is a block diagram illustrating a configuration example of an imaging element of the imaging device according to the first embodiment of the present invention.

FIG. 3 is a circuit diagram illustrating a configuration example of the imaging element of the imaging device according to the first embodiment of the present invention.

FIG. 4 is a schematic diagram illustrating a color filter arrangement of the imaging element of the imaging device according to the first embodiment of the present invention.

FIG. 5 is a schematic diagram illustrating another example of a color filter arrangement of the imaging element.

FIG. 6 is a timing diagram illustrating a vertical scan operation in the imaging element of the imaging device according to the first embodiment of the present invention.

FIG. 7 is a timing diagram illustrating a readout operation in the imaging element of the imaging device according to the first embodiment of the present invention.

FIG. 8 is a timing diagram illustrating a reset operation in the imaging element of the imaging device according to the first embodiment of the present invention.

FIG. 9 is a schematic diagram illustrating an operation in an RGBW12 signal processing unit of the imaging device according to the first embodiment of the present invention.

FIG. 10 is a schematic diagram illustrating an operation in a high accuracy interpolation unit of the imaging device according to the first embodiment of the present invention.

FIGS. 11A, 11B, 11C and 11D are diagrams illustrating a method of detecting a directionality of luminance change in RGBW12 arrangement.

FIG. 12 is a graph illustrating a relationship of the incident light amount and the signal output and the resolution in the imaging device according to the first embodiment of the present invention.

FIG. 13 is a flowchart illustrating a signal processing method in the imaging device according to the first embodiment of the present invention.

FIG. 14 is a block diagram illustrating a general configuration of an imaging system according to a second embodiment of the present invention.

FIG. 15A is a diagram illustrating a configuration example of an imaging system according to a third embodiment of the present invention.

FIG. 15B is a diagram illustrating a configuration example of a movable object according to the third embodiment of the present invention.

### DESCRIPTION OF THE EMBODIMENTS

Preferred embodiments of the present invention will now be described in detail in accordance with the accompanying drawings.

### First Embodiment

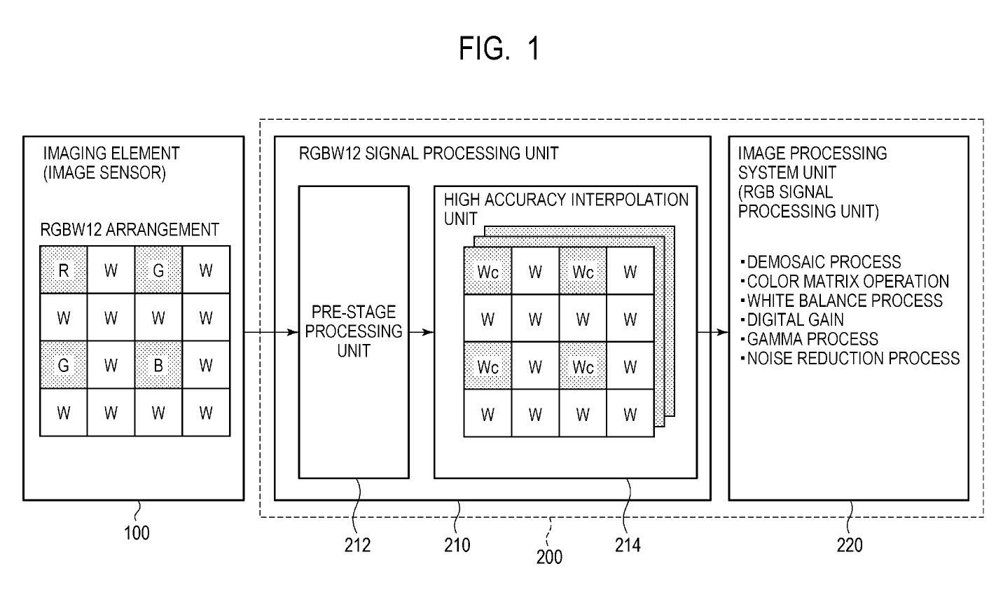

An imaging device and a method of driving the same according to a first embodiment of the present invention will be described with reference to FIG. 1 to FIG. 13.

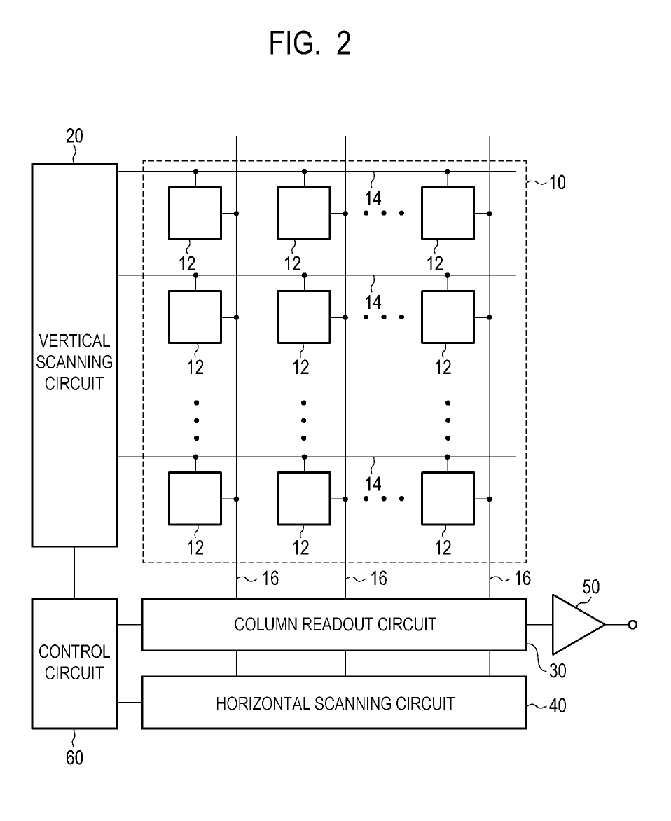

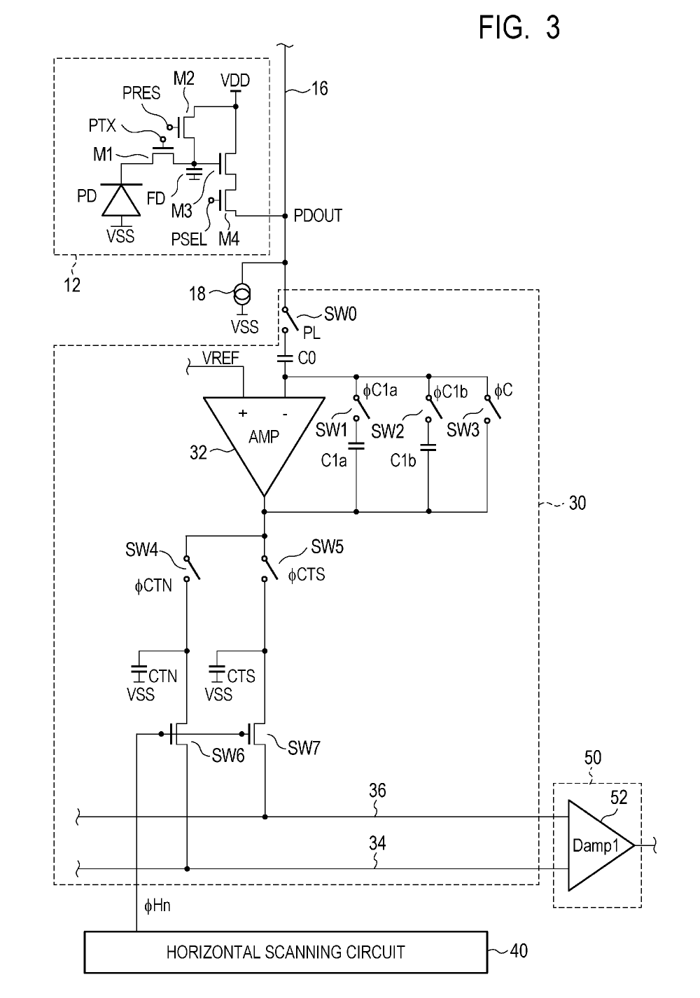

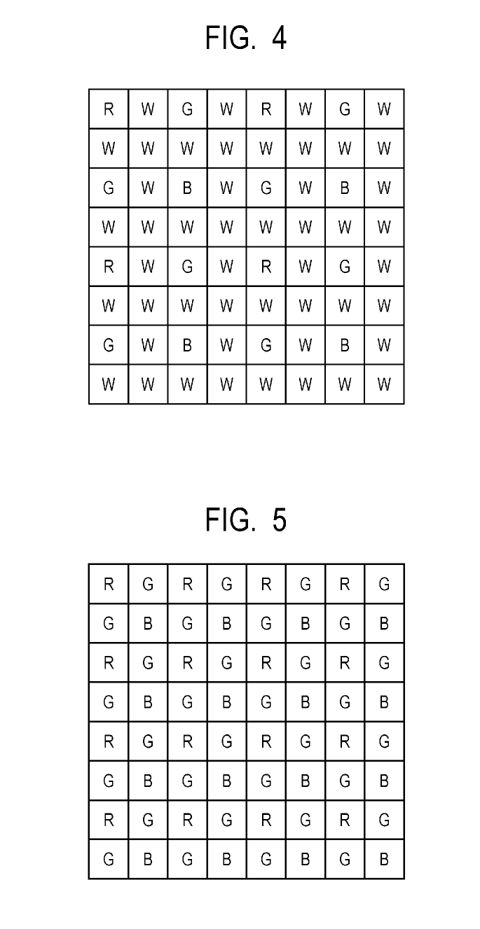

First, a general configuration of the imaging device according to the present embodiment will be described by using FIG. 1 to FIG. 5. FIG. 1 is a block diagram illustrating a general configuration of the imaging device according to the present embodiment. FIG. 2 is a block diagram illustrating a configuration example of an imaging element. FIG. 3 is a circuit diagram illustrating a configuration example of the imaging element. FIG. 4 and FIG. 5 are schematic diagrams illustrating a color filter arrangement used in the imaging element.

As illustrated in FIG. 1, the imaging device according to the present embodiment includes an imaging element 100 and a signal processing unit 200.

The imaging element 100 converts a light signal (object image) received through an optical system (not illustrated) into an electric signal and outputs the converted signal. The imaging element 100 is formed of a so-called single-plate-type color sensor in which a color filter (hereinafter, also referred to as “CF”) is arranged on a CMOS image sensor or a CCD image sensor, for example. The term “RGBW12 arrangement” illustrated in FIG. 1 represents a color filter arrangement used in the imaging element 100 according to the present embodiment. The RGBW12 arrangement will be described later in detail.

The signal processing unit 200 performs signal processing described later on a signal output from the imaging element 100. The signal processing unit 200 includes an RGBW12 signal processing unit 210 and an image processing system unit 220. The RGBW12 signal processing unit 210 includes a pre-stage processing unit 212 and a high accuracy interpolation unit 214.

The RGBW12 signal processing unit 210 processes output signals from the imaging element 100 having a color filter arrangement of the RGBW12 arrangement. The pre-stage processing unit 212 performs as appropriate pre-processing of signal processing on the output signals from the imaging element 100, that is, a correction process such as offset correction or gain correction on each signal. The high accuracy interpolation unit 214 performs an accurate interpolation process on the output signals from the pre-stage processing unit 212. The high accuracy interpolation unit 214 has a function as a luminance information acquisition unit that acquires a luminance value of a color pixel based on the signal output from the W pixel. Further, the high accuracy interpolation unit 214 has a function as a color acquisition unit that acquires a color ratio from the color values of the color pixels and the luminance value of the W pixel and acquires a color component of each pixel from the acquired color ratio.

The image processing system 220 uses output from the RGBW12 signal processing unit 210 to generate an output image. The image processing system unit 220 is a functional block that generates an RGB color image and thus can be referred to as an RGB signal processing unit. To form a color image from the output from the imaging element 100, the image processing system unit 220 performs various processes such as a demosaic process, a color matrix operation, a white balance process, a digital gain, a gamma process, a noise reduction process, or the like where appropriate. Among these processes, demosaic process is particularly important for resolution information, and an advanced interpolation process is performed assuming a CF with the Bayer arrangement.

The imaging element 100 and the signal processing unit 200 may be provided on the same chip or may be provided on different chips or devices. When configured to be provided on a single chip, the imaging element 100 and the signal processing unit 200 may be both provided on a single semiconductor substrate or may be separately provided on different semiconductor substrates and then stacked. Further, the imaging element 100 and the signal processing unit 200 are not necessarily required to be configured as a single unit, but the signal processing unit 200 may be configured as a signal processing device or an image processing device that processes a signal output from the imaging element 100 or the imaging device.

The imaging element 100 includes an imaging region 10, a vertical scanning circuit 20, a column readout circuit 30, a horizontal scanning circuit 40, an output circuit 50, and a control circuit 60, as illustrated in FIG. 2.

In the imaging region 10, a plurality of pixels 12 are provided in a matrix over a plurality of rows and a plurality of columns. For example, a total of 2073600 pixels including 1920 pixels in the column direction and 1080 pixels in the row direction are arranged in the imaging region 10. The number of pixels arranged in the imaging region 10 is not particularly limited, and a larger number of pixels or a smaller number of pixels may be applicable.

On each row of the imaging region 10, a control line 14 is arranged extending in a first direction (horizontal direction in FIG. 2). The control line 14 is connected to the pixels 12 aligned in the first direction, respectively, to form a signal line common to these pixels 12. The first direction in which the control line 14 extends may be referred to as a row direction in the present specification. Further, on each column of the imaging region 10, an output line 16 is arranged extending in a second direction intersecting with the first direction (vertical direction in FIG. 2). The output line 16 is connected to the pixels 12 aligned in the second direction, respectively, to form a signal line common to these pixels 12. The second direction in which the output line 16 extends may be referred to as a column direction in the present specification.

The control line 14 on each row is connected to the vertical scanning circuit 20. The vertical scanning circuit 20 supplies a control signal used for controlling a transistor of the pixel 12 to be turned on (conductive state) or off (nonconductive state). The output line 16 on each column is connected to the column readout circuit 30. The column readout circuit 30 performs a predetermined process such as an amplification process, for example, on the pixel signal read out via the output line 16 and holds the processed signal. The horizontal scanning circuit 40 supplies a control signal used for controlling a switch connected to a signal holding unit of each column of the column readout circuit 30. The output circuit 50 is formed of a buffer amplifier or a differential amplifier circuit and outputs a pixel signal read out from the signal holding unit of the column readout circuit 30 in response to the control signal from the horizontal scanning circuit 40 to the signal processing unit 200. The control circuit 60 is a circuit unit that supplies, to the vertical scanning circuit 20, the column readout circuit 30, and the horizontal scanning circuit 40, control signals for controlling the operations or the timings thereof. Some or all of the control signals to be supplied to the vertical scanning circuit 20, the column reading circuit 30, and the horizontal scanning circuit 40 may be supplied from the outside of the imaging element 100.

Each of the pixels 12 includes a photoelectric converter PD, a transfer transistor M1, a reset transistor M2, an amplifier transistor M3, and a select transistor M4, as illustrated in FIG. 3. The photoelectric converter PD is a photodiode, for example. The photodiode forming the photoelectric converter PD has the anode connected to a reference voltage node (voltage VSS) and the cathode connected to the source of the transfer transistor M1. The drain of the transfer transistor M1 is connected to the source of the reset transistor M2 and the gate of the amplifier transistor M3. The connection node of the drain of the transfer transistor M1, the source of the reset transistor M2, and the gate of the amplifier transistor M3 is a so-called floating diffusion FD. The floating diffusion FD includes a capacitance component, functions as a charge holding portion, and forms a charge-to-voltage converter having that capacitance component. The drain of the reset transistor M2 and the drain of the amplifier transistor M3 are connected to a power supply node (voltage VDD). The source of the amplifier transistor M3 is connected to the drain of the select transistor M4. The source of the select transistor M4 that also serves as an output node PDOUT of the pixel 12 is connected to the output line 16. A current source 18 is connected to the output line 16.

In the case of the pixel 12 of the circuit configuration illustrated in FIG. 3, the control line 14 on each row includes a signal line connected to the gate of the transfer transistor M1, a signal line connected to the gate of the reset transistor M2, and a signal line connected to the gate of the amplifier transistor M3. A control signal PTX is supplied to the transfer transistor M1 from the vertical scanning circuit 20 via the control line 14. A control signal PRES is supplied to the reset transistor M2 from the vertical scanning circuit 20 via the control line 14. A control signal PSEL is supplied to the select transistor M4 from the vertical scanning circuit 20 via the control line 14. The plurality of pixels 12 in the imaging region 10 are controlled by the control signals PTX, PRES, and PSEL supplied from the vertical scanning circuit 20 on a row-by-row basis. When each transistor of the pixel 12 is formed of an N-type transistor, the transistor is in an on-state when the corresponding control signal is at a High-level (H-level), and the transistor is in an off-state when the corresponding control signal is at a Low-level (L-level).

As illustrated in FIG. 3, the column readout circuit 30 includes a column amplifier 32, capacitors C0, C1a, C1b, CTN, and CTS, and switches SW0, SW1, SW2, SW3, SW4, SW5, SW6, and SW7 on each column of the imaging region 10.

The column amplifier 32 is formed of the differential amplifier circuit having an inverting input node, a non-inverting input node, and an output node. The inverting input node of the column amplifier 32 is connected to the output line 16 via the switch SW0 driven by a signal PL and the capacitor C0. A voltage VREF is supplied to the non-inverting input node of the column amplifier 32. A first feedback path formed of the switch SW1 driven by a signal ϕC1a and the capacitor C1a, which are connected in series, is provided between the inverting input node and the output node of the column amplifier 32. Further, a second feedback path formed of the switch SW2 driven by a signal ϕC1b and the capacitor C1b, which are connected in series, is provided between the inverting input node and the output node of the column amplifier 32. Furthermore, a third feedback path formed of the switch SW3 driven by a signal ϕC is provided between the inverting input node and the output node of the column amplifier 32.

To the output node of the column amplifier 32, the capacitor CTN and one primary node of the switch SW6 are connected via the switch SW4, and the capacitor CTS and one primary node of the switch SW7 are connected via the switch SW5, respectively. The switches SW4 and SW5 are driven by signals ϕCTN and ϕCTS, respectively.

The other primary node of the switch SW6 is connected to a horizontal output line 34. Further, the other primary node of the switch SW7 is connected to a horizontal output line 36. The horizontal scanning circuit 40 outputs signals ϕHn subsequently to control nodes of the switches SW6 and SW7 of the column readout circuit 30 on each column. The output circuit 50 includes an output amplifier 52. The horizontal output lines 34 and 36 are connected to the output amplifier 52.

On each pixel 12 arranged in the imaging region 10, a color filter having predetermined spectral sensitivity characteristics is arranged in accordance with a color filter arrangement (hereinafter, referred to as “CF arrangement”) illustrated in FIG. 4. Each rectangular region corresponds to one pixel 12 in FIG. 4. That is, FIG. 4 illustrates a CF arrangement corresponding to a pixel array of eight rows by eight columns. The color filters used in the present embodiment includes a red filter R, a green filter G, a blue filter B, and a white filter W. In the following description, the pixel 12 on which the red filter R is provided is referred to as “R pixel”, the pixel 12 on which the green filter G is provided is referred to as “G pixel”, and the pixel 12 on which the blue filter B is provided is referred to as “B pixel”. The R pixel, the G pixel, and the B pixel are pixels mainly used for outputting color information and may be referred to as “color pixels” or “RGB pixels”. Further, the pixel 12 on which the white filter W is provided is referred to as “W pixel”. The W pixel is a pixel mainly used for outputting luminance information and may be referred to as “white pixel”.

The W pixel is a pixel that directly detects an incident light without color separation. The W pixel is characterized by a wide transmission wavelength range and high sensitivity in the spectral sensitivity characteristics compared to the R pixel, the G pixel, and the B pixel and has the widest wavelength full width at half maximum of the transmission wavelength range in the spectral sensitivity characteristics, for example. Typically, the transmission wavelength range in the spectral sensitivity characteristics of the W pixel covers the transmission wavelength range in the spectral sensitivity characteristics of the R pixel, the G pixel, and the B pixel.

In the CF arrangement illustrated in FIG. 4, a block of contiguous four rows by four columns is the smallest repetition unit. In the 16 pixels 12 included in such a unit block, the ratio of the R pixel, the G pixel, the B pixel, and the W pixel is R:G:B:W=1:2:1:12. This CF arrangement having the 12 W pixels in a unit block of four rows by four columns is referred to as “RGBW12 arrangement” in the present specification. The ratio of the RGB pixels to the W pixels, RGB:W is 1:3 in the RGBW12 arrangement. The RGBW12 arrangement is featured in that every color pixel of the R pixel, the G pixel, and the B pixel is surrounded by the W pixels, and the ratio of the W pixels of all the pixels is ¾.

In other words, the RGBW12 arrangement includes color pixels as first pixels and white pixels as second pixels, and the total number of the second pixels is three times (twice or more) the total number of the first pixels. The first pixels include multiple types of pixels (the R pixel, the G pixel, and the B pixel) each of which outputs a signal including color information of any of a plurality of colors (R, G, B). The second pixel has higher sensitivity than the first pixel. Note that, while the imaging element 100 may include not only effective pixels but also a pixel that does not output a signal used for forming an image, such as an optical black pixel, a dummy pixel, a null pixel, or the like, which is not included in the first pixel and the second pixel described above.

When using the RGBW12 arrangement, since the RGB pixels are surrounded by only the W pixels, the accuracy in acquiring a W value (luminance value) of the RGB pixel portion by using interpolation is improved. Since the luminance value of the RGB pixel portion can be interpolated with high accuracy, an image with high resolution can be obtained. Here, the RGB pixels being surrounded by the W pixels means that each of the W pixels is arranged adjacent to each of the R pixel, the G pixel, and the B pixel in the vertical direction, the horizontal direction, and the diagonal direction in a planar view.

As a CF arrangement used in acquiring a color image, a so-called Bayer arrangement is known. In the Bayer arrangement, as illustrated in FIG. 5, two G pixels are arranged at one pair of diagonal positions and an R pixel and a B pixel are arranged at the other pair of diagonal positions in a pixel block of two rows by two columns that is the minimum repetition unit. A predetermined interpolation process is performed also when a color image is formed in a single-plate area sensor using this Bayer arrangement. For example, there is no information on G or B in the portion of the R pixel. Therefore, values of G and B of an R pixel portion are interpolated based on information of G pixels and B pixels surrounding the R pixel. In the Bayer arrangement, the resolution is determined by G pixels the number of which is the largest and which are arranged in a checkered pattern.

Since the ratio of W pixels that determines a resolution is larger in the RGBW12 arrangement, it is possible to acquire an image with a higher resolution than in a case of a CF arrangement in which pixels which determine the resolution are arranged in a checkered pattern as with the Bayer arrangement. That is, information with a higher spatial frequency (that is, a finer pitch) can be acquired than in a case of a CF arrangement in which pixels which determine the resolution are arranged in a checkered pattern. Therefore, an image with a sufficiently high resolution can be obtained by merely calculating values of portions including no W pixel (that is, a portion including color pixels) from the average of eight pixels nearby. Further, interpolation can be performed by detecting the edge directionality based on edge information or information on a periodical shape or the like. In this case, it is possible to obtain a sharper image (that is, a higher resolution image) than in a case of using the average of eight pixels nearby.

While various CF arrangements are possible, it is preferable to increase the number of pixels which mainly create the resolution (G pixels in the Bayer arrangement) in order to acquire an image with a higher resolution than the resolution in a single-plate image sensor. In particular, G pixels which create the resolution are arranged in a checkered pattern in the Bayer arrangement, and thus an interpolation error may occur. In this regards, since the RGBW12 arrangement includes more pixels which create the resolution (W pixels), the interpolation error can be reduced as much as possible.

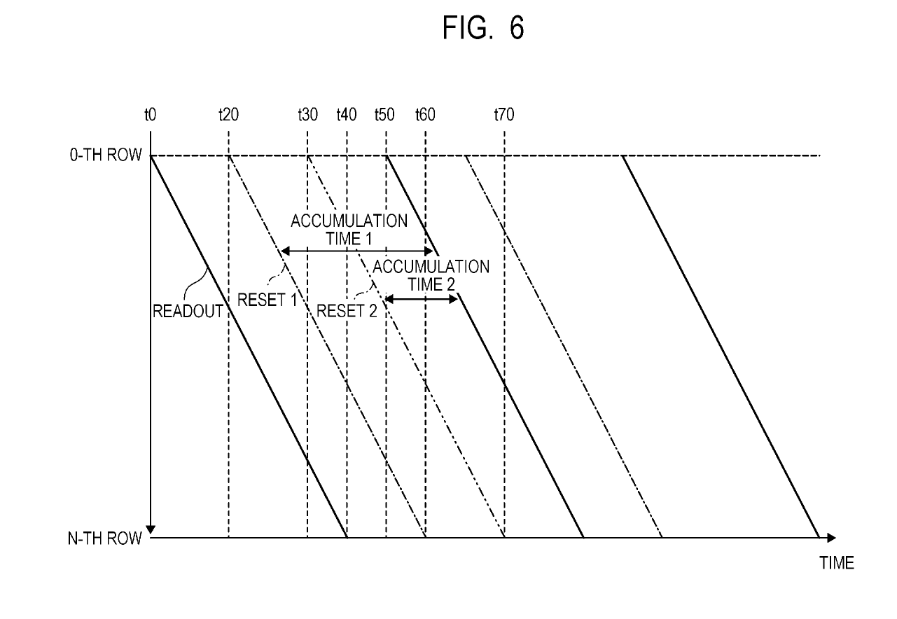

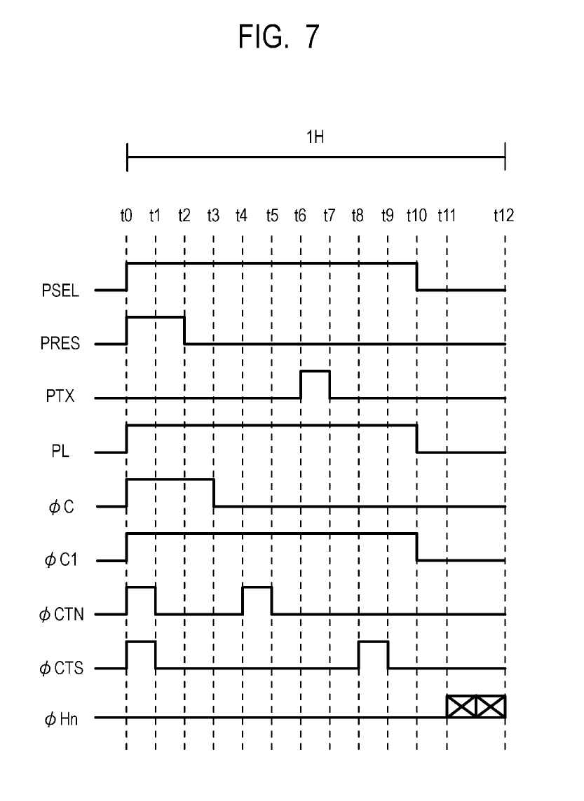

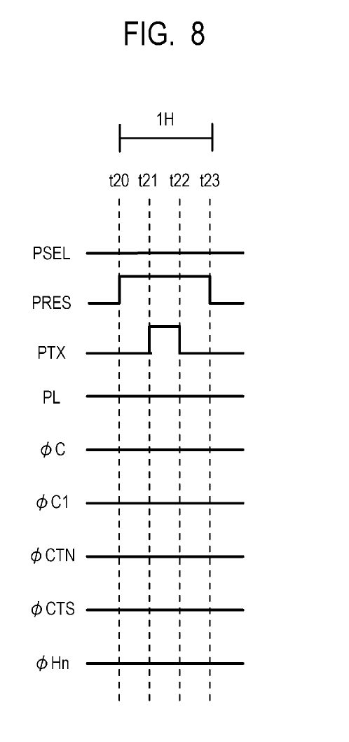

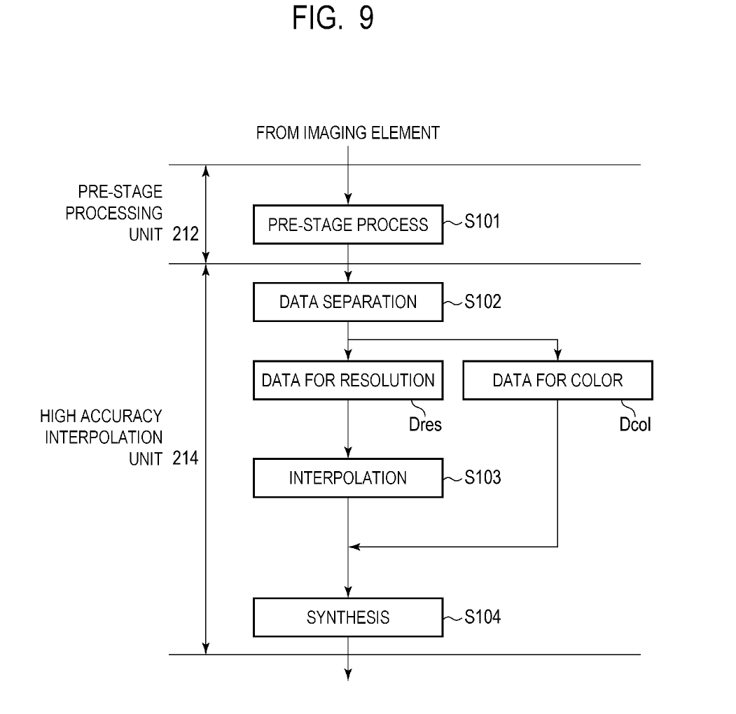

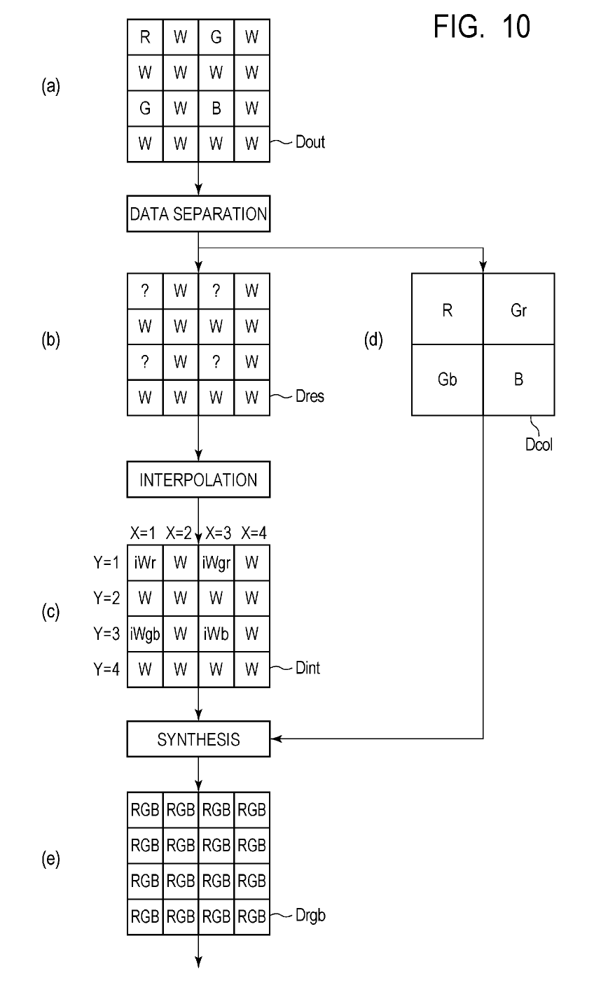

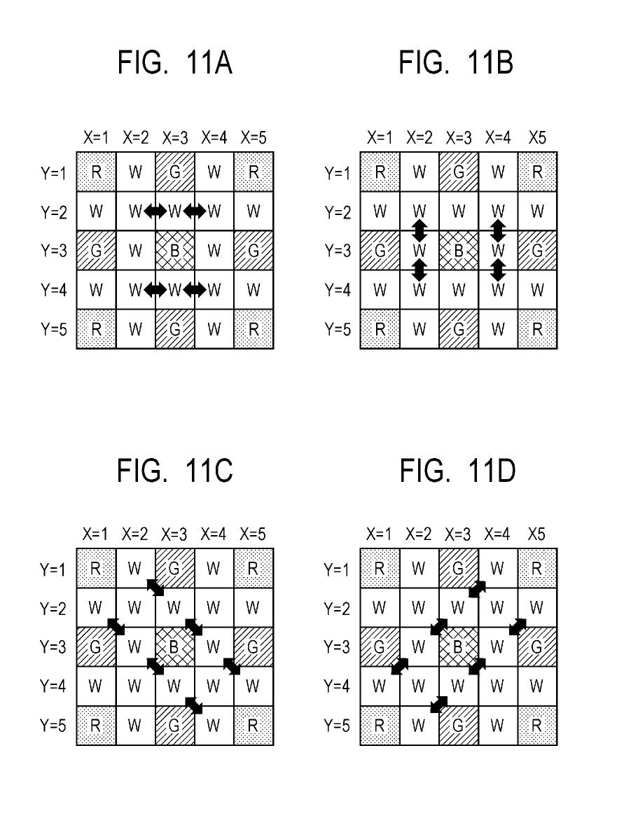

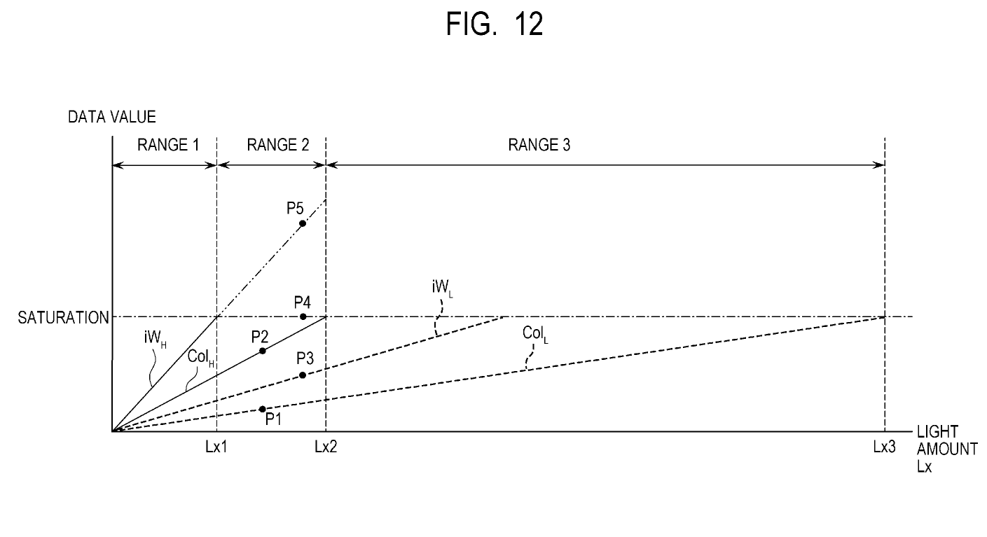

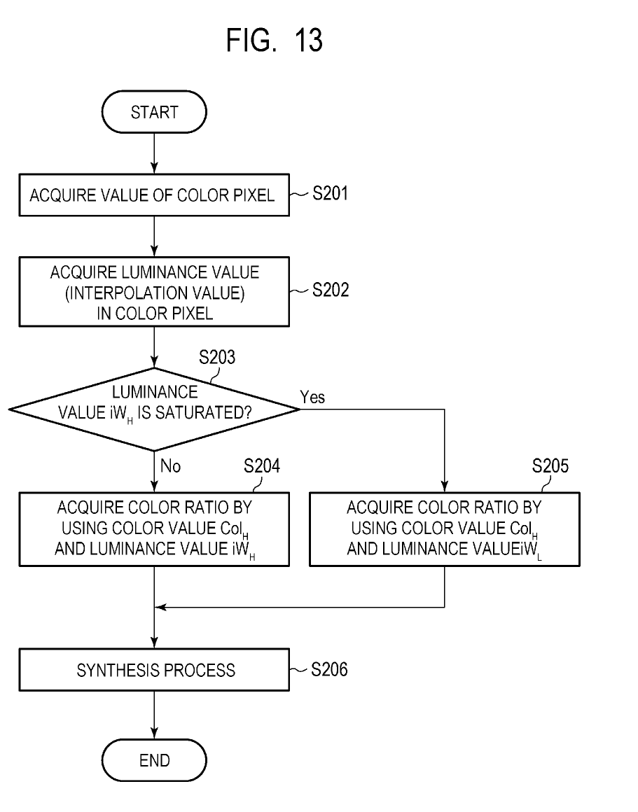

Next, the operation of the imaging device according to the present embodiment will be described by using FIG. 1 to FIG. 12. FIG. 6 is a timing diagram illustrating a vertical scan operation in the imaging element of the imaging device according to the present embodiment. FIG. 7 is a timing diagram illustrating a readout operation in the imaging element of the imaging device according to the present embodiment. FIG. 8 is a timing diagram illustrating a reset operation in the imaging element of the imaging device according to the present embodiment. FIG. 9 is a schematic diagram illustrating an operation in an RGBW12 signal processing unit of the imaging device according to the present embodiment. FIG. 10 is a schematic diagram illustrating an operation in a high accuracy interpolation unit of the imaging device according to the present embodiment. FIG. 11A to FIG. 11D are diagrams illustrating a method of detecting a directionality of luminance change in RGBW12 arrangement. FIG. 12 is a graph illustrating a relationship of the incident light amount and the signal output and the resolution in the imaging device according to the present embodiment. FIG. 13 is a flowchart illustrating a signal processing method in the imaging device according to the present embodiment.

FIG. 6 is a timing diagram illustrating a so-called vertical scan operation that is an operation of reading out signals sequentially on a row-by-row basis from the pixels 12 belonging to a plurality of rows forming the imaging region 10. In FIG. 6, it is assumed that signals are read out sequentially on a row-by-row basis from the pixels 12 belonging to (N+1) rows from the 0-th row to the N-th row. In FIG. 6, the horizontal axis represents time, and the vertical axis represents the row position. Each solid line represents a start timing of a readout operation on each row, and each one-dot chain line and each two-dot chain line represent a start timing of a reset operation on each row.

At time t0, a readout operation from the pixel 12 on the 0-th row is started. After the completion of the readout operation from the pixel 12 on the 0-th row, the process proceeds to a readout operation from the pixel 12 on the first row. Similarly, readout operations are sequentially performed from the second row to the N-th row, and a readout operation from the pixel 12 on the N-th row is started at time t40.

Further, at a predetermined time t20 after the completion of the readout operation from the pixel 12 on the 0-th row, a reset operation of the pixel 12 on the 0-th row (“reset 1” in FIG. 6) is performed. Alternatively, at a predetermined time t30 after the completion of the readout operation from the pixel 12 on the 0-th row, a reset operation of the pixel 12 on the 0-th row (“reset 2” in FIG. 6) is performed. The reset operations of the pixels 12 are performed sequentially on a row-by-row basis in a similar manner to the readout operations. The reset operation of the pixel 12 on the N-th row will be performed at time t60 or time t70.

Further, at a predetermined time t50 after the completion of the readout operation from the pixel 12 on the N-th row, the process proceeds to a readout operation of the next frame and repeatedly performs the same operation as the operation from the time t0. Note that the period from time t0 to time t50 is determined by a framerate.

In the timing diagram described above, a period from a reset operation to a readout operation on each row is defined as an accumulation time of signal charges in the photoelectric converter PD of the pixel 12 (hereinafter, simply referred to as “accumulation time”). When a reset scan to perform a reset operation of the first row at time t20 and perform a reset operation of the N-the row at time t60 (“reset 1” in FIG. 6) is performed, a period corresponding to the period from time t20 to time t50 corresponds to the accumulation time of each pixel 12 (“accumulation time 1” in FIG. 6). Further, when a reset scan to perform a reset operation of the first row at time t30 and perform a reset operation of the N-the row at time t70 (“reset 2” in FIG. 6) is performed, a period corresponding to the period from time t30 to time t50 corresponds to the accumulation time of each pixel 12 (“accumulation time 2” in FIG. 6). That is, by changing the timing of a reset operation, it is possible to change the accumulation time (exposure condition) of the pixel 12.

FIG. 7 is a timing diagram illustrating a readout operation of the pixel 12. The timing diagram of FIG. 7 illustrates a readout operation within one horizontal period (1H period). Note that, while a readout operation from the pixel 12 on a particular column is focused on in the following description, readout operations from the pixels 12 on different columns belonging to the same row are performed simultaneously in parallel.

First, at time t0, the vertical scanning circuit 20 controls the control signal PSEL on a row to be read out to H-level to turn on the select transistor M4. Thereby, the row to be read out is selected, and the amplifier transistors M3 of the pixels 12 belonging to the row of interest (selected row) are connected to the output lines 16 via the select transistors M4.

Further, at the same time t0, the vertical scanning circuit 20 controls the control signal PRES on the row to be read out to H-level to turn on the reset transistor M2. Thereby, the floating diffusions FD of the pixels 12 belonging to the selected row are connected to the power supply node (voltage VDD) via the reset transistors M2, and the potentials of the floating diffusions FD of the pixels 12 are reset. The amplifier transistor M3 outputs a signal based on the reset potential of the floating diffusion FD (N-signal) to the output line 16 via the select transistor M4.

Further, at the same time t0, the control circuit 60 controls the signal PL to H-level to turn the switch SW0 into a conductive state. This causes the output line 16 to be connected to the capacitor C0.

Further, at the same time t0, the control circuit 60 controls the signals ϕC, ϕC1a, ϕC1b, ϕCTN, and ϕCTS to H-level to turn the switches SW1, SW2, SW3, SW4, and SW5 into a conductive state. This causes the capacitors C1a, C1b, CTN, and CTS to be in a reset state. The potentials of the capacitors CTN and CTS become the voltage VREF. Note that the signal ϕC1 in FIG. 7 indicates one of the signals ϕC1a and ϕC1b which is controlled to H-level in a period from time t0 to time t10.

Next, at time t1, the control circuit 60 controls the signals ϕCTN and ϕCTS to L-level to turn the switches SW4 and SW5 into a nonconductive state. Thereby, the reset state of the capacitors CTN and CTS are released.

Next, at time t2, the vertical scanning circuit 20 controls the control signal PRES to L-level to turn on the reset transistor M2. Thereby, the reset of the potential of the floating diffusion FD is released. The potential in which a reset noise (kTC noise) is mixed is held in the floating diffusion FD.

Next, at time t3, the control circuit 60 controls the signal ϕC to L-level to turn the switch SW3 into a nonconductive state. Thereby, reset is released with the column amplifier 32 being reset by the N-signal. Thereby, the column amplifier 32 is in a state of amplifying the difference between a signal from the pixel 12 and the N-signal at a gain determined by the ratio C0/C1 and outputting the amplified signal. Further, the potential corresponding to the N-signal is clamped in the capacitor C0 at the voltage VREF.

The gain of the column amplifier 32 can be determined by appropriately controlling the signals ϕC1a and ϕC1b. That is, if only the signal ϕC1a of the signals ϕC1a and ϕC1b is at H-level, the gain of the column amplifier 32 will be C0/C1a. Hereinafter, the gain at this time is referred to as a gain G1. If both of the signals ϕC1a and C1b are at H-level, the gain of the column amplifier 32 will be C0/(C1a+C1b). Hereinafter, the gain at this time is referred to as a gain G2. If only the signal ϕC1b of the signals ϕC1a and ϕC1b is at H-level, the gain of the column amplifier 32 will be C0/C1b. Hereinafter, the gain at this time is referred to as a gain G3. The signal ϕC1 in FIG. 7 indicates one of the signals ϕC1a and ϕC1b which is controlled to H-level.

Next, at time t4, the control circuit 60 controls the signal ϕCTN to H-level to turn the switch SW4 into a conductive state. Thereby, the output terminal of the column amplifier 32 is connected to the capacitor CTN via the switch SW4.

Next, at time t5, the control circuit 60 controls the signal ϕCTN to L-level to turn the switch SW4 into a nonconductive state. Thereby, a signal obtained by amplifying the N-signal at a predetermined gain by the column amplifier 32 is sampled and held in the capacitor CTN. Note that, at this time, the offset of the column amplifier 32 is held at the same time.

Next, in a period from time t6 to time t7, the vertical scanning circuit 20 controls the control signal PTX to H-level to turn on the transfer transistor M1. Thereby, charges accumulated in the photoelectric converter PD are transferred to the floating diffusion FD, and the amplifier transistor M3 outputs a signal based on the potential of the floating diffusion FD to the output line 16 via the select transistor M4.

The signal output by the amplifier transistor M3 is a signal based on charges that have been accumulated in the photoelectric converter PD. A signal output by the amplifier transistor M3 based on charges that have been accumulated by the photoelectric converter PD is referred to as a light signal (which may be denoted as an S-signal).

Next, at time t8, the control circuit 60 controls the signal ϕCTS to H-level to turn the switch SW5 into a conductive state. Thereby, the output terminal of the column amplifier 32 is connected to the capacitor CTS via the switch SW5.

Next, at time t9, the control circuit 60 controls the signal ϕCTS to L-level to turn the switch SW5 into a nonconductive state. Thereby, a signal obtained by amplifying a light signal at a predetermined gain by the column amplifier 32 is sampled and held in the capacitor CTS.

Next, at time t10, the vertical scanning circuit 20 controls the control signal PSEL to L-level to turn off the select transistor M4 and thereby separate the pixel 12 from the output line 16. Further, the vertical scanning circuit 20 controls the signal PL to L-level to turn the switch SW0 into a nonconductive state and thereby separate the input of the column amplifier 32. Further, the vertical scanning circuit 20 controls the signal ϕC1 to L-level to turn the switches SW1 and SW2 into a nonconductive state and thereby stops the amplification operation of the column amplifier 32.

Next, in a period from time t11 to time t12, the horizontal scanning circuit 40 performs an operation of outputting the signal ϕHn sequentially to each column of the column readout circuit 30, namely, a horizontal scan. Thereby, the output amplifier 52 sequentially outputs a signal based on a signal held in the capacitors CTN and CTS to the outside. The offset component of the column amplifier 32 is subtracted from the output signal of the output amplifier 52.

FIG. 8 is a timing diagram illustrating the reset operation of the pixel 12. The timing diagram of FIG. 8 illustrates a reset operation within one horizontal period (1H period). Note that, while a reset operation of the pixel 12 on a particular column is focused on in the following description, reset operations of the pixels 12 on different columns belonging to the same row are performed simultaneously in parallel. Note that a case of a reset scan starting from time t20 (reset 1) will now be described as an example, the same applies to a case of a reset scan starting from time t30 (reset 2).

First, at time t20, the vertical scanning circuit 20 controls the control signal PRES to H-level to turn on the reset transistor M2. Thereby, the floating diffusion FD is connected to a power supply node (voltage VDD) via the reset transistor M2, and the potential of the floating diffusion FD is reset.

Next, in a period from the time t21 to the time t22, the vertical scanning circuit 20 controls the control signal PTX to H-level to turn on the transfer transistor 24. Thereby, the cathode of the photoelectric converter PD is reset to the same potential as the floating diffusion FD, that is, the voltage VDD.

Next, at time t23, the vertical scanning circuit 20 controls the control signal PRES to L-level to turn off the reset transistor M2. Thereby, the reset state is released.

Other signals, that is, the control signals PSEL and signals PL, ϕC, ϕC1a, ϕC1b, ϕCTN, ϕCTS, and ϕHn are maintained in L-level during the reset period from time t20 to time t23.

A pixel signal output from the imaging element 100 by the readout operation described above is processed in the signal processing unit 200 in accordance with the flow illustrated in FIG. 9.

The pixel signal input from the signal processing unit 200 is first input to the pre-stage processing unit 212 of the RGBW12 signal processing unit 210. The pre-stage processing unit 212 appropriately performs, on the pixel signal (input signal Din), a correction process (pre-stage process) such as offset (OFFSET) correction, gain (GAIN) correction, or the like to create a corrected output signal (data Dout) (step S101). This process is typically expressed by the following Equation (1).

Dout=(Din−OFFSET)·GAIN (1)

This correction can be performed in various units. For example, correction may be performed on a pixel 12 basis, on a column amplifier 32 basis, on an analog-digital conversion (ADC) unit basis, on an output amplifier 52 basis, or the like. With the correction of the pixel signal, so-called fixed pattern noise can be reduced, and thereby a higher quality image can be obtained.

Next, the data Dout processed by the pre-stage processing unit 212 is input to the high accuracy interpolation unit 214. In the high accuracy interpolation unit 214, as illustrated in FIG. 9, a data separation process (step S102), an interpolation process (step S103), and a synthesis process (step S104) are sequentially performed. In the data separation process of step S102, data processed by the pre-stage processing unit 212 is separated into data Dres for resolution and data Dcol for color. In the interpolation process of step S103, an interpolation process is performed on the data Dres for resolution. In the synthesis process of step S104, data Dint for resolution on which an interpolation process is performed and the data Dcol for color separated in step S102 are synthesized to generate RGB data Drgb.

The process in the high accuracy interpolation unit 214 will be more specifically described by using FIG. 10. Diagram (a) in FIG. 10 schematically illustrates output data from a pixel block of four rows by four columns that is the minimum repetition unit in the RGBW12 arrangement. A case where output data from such a pixel block is input to the high accuracy interpolation unit 214 and the processes of step S102 to step S104 are performed is illustrated here as an example. Note that, in the actual implementation, output data from all the pixels 12 forming the imaging region 10 is processed in the same procedure.

In step S102, the data Dout in Diagram (a) in FIG. 10 is separated into the data Dres for resolution, which comprises data on white pixels (W pixels), and the data Dcol for color, which comprises data on color pixels (R pixel, G pixels, B pixel). As illustrated in Diagram (b) in FIG. 10, the separated data Dres for resolution is in a state where, out of 16 pixels of 4 rows by 4 columns, pixel values of 4 pixels 12 (data on luminance information) in which color pixels are originally arranged are unknown (represented by “?” in the diagram). Further, as illustrated in Diagram (d) in FIG. 10, the separated data Dcol for color is data on 4 pixels of 2 rows by 2 columns extracted from 16 pixels of 4 rows by 4 columns, which is data with a low resolution (spatially coarse). Note that, in Diagram (d) in FIG. 10, “Gr” and “Gb” each represent data of a G pixel. The notation is different such as “Gr” or “Gb” to distinguish that data is from different G pixels.

In step S103, an interpolation process is performed on the separated data Dres for resolution, and pixel values of four pixels whose pixel values are unknown (“?” in the diagram) are filled. The interpolation process in step S103 is performed in a luminance value acquisition unit (not illustrated) of the high accuracy interpolation unit 214. Various methods may be employed for a method of interpolating pixel values. The method may be, for example, a method of acquiring the average of surrounding eight pixels, a method of acquiring the average of four pixels, namely, upper, under, left, and right pixels (bilinear method), a method of detecting edges of surrounding pixels to perform interpolation in the direction orthogonal to the edge direction, and a method of detecting a pattern such as a thin line to perform interpolation in the direction thereof, or the like.

For illustration purposes of the interpolation method, X coordinate and Y coordinate are added in Diagram (c) in FIG. 10. For example, a pixel at coordinates (3, 3) is denoted as “iWb”. In Diagram (c) in FIG. 10, “iW” means the data on W acquired by interpolation, and “r”, “gr”, “gb”, and “b” appended to “iW” represent the correspondence relationship with the original color pixel. When interpolation data on a particular pixel is indicated in the present specification, the combination of these symbols and coordinates is used. For example, the data of W at coordinates (3, 3) is denoted as “iWb (3, 3)”.

When a pixel value is interpolated by the average of the surrounding eight pixels, for example, the luminance interpolation value iWb (3, 3) at the pixel at the coordinates (3, 3) can be acquired from the following Equation (2).

$${iWb}_{( 3 , 3 )} = \frac{\begin{matrix}{W}_{( 2 , 2 )} + {W}_{( 3 , 2 )} + {W}_{( 4 , 2 )} + {W}_{( 2 , 3 )} + \\ {W}_{( 4 , 3 )} + {W}_{( 2 , 4 )} + {W}_{( 3 , 4 )} + {W}_{( 4 , 4 )}\end{matrix}}{8} \qquad ( 2 )$$

While FIG. 10 illustrates only the pixel group of four by four, this pattern is repeatedly arranged in the imaging region 10. Therefore, the interpolation values iWr (1, 1), iWg (3,1), and iWg (1,3) can be acquired from the W values of surrounding eight pixels in a similar manner to the interpolation value iWb (3, 3).

The directivity of a luminance change may be detected from pixel values of surrounding pixels, and the interpolation of pixel values in the data Dres for resolution may be performed based on the detected directionality of a luminance change. Performing an interpolation process based on the directivity of a luminance change enables more accurate interpolation of pixel values.

FIG. 11A to FIG. 11D are diagrams illustrating a method of detecting the directivity of a luminance change in the RGBW12 arrangement. In FIG. 11A to FIG. 11D, for illustration purposes, X coordinate and Y coordinate are added. For example, the B pixel at X=3 and Y=3 is denoted as pixel B (3, 3). A method of deriving correlation of pixel B (3, 3) by cutting out a region including five by five pixels about pixel B (3, 3) as the center is now described.

FIG. 11A is a schematic diagram illustrating pixels used for calculation when deriving correlation of the horizontal direction (X-direction, row direction) of pixel B (3, 3). Each arrow illustrated in FIG. 11A indicates a pair of pixels used for calculating a differential value. That is, when deriving correlation in the horizontal direction of pixel B (3, 3), each differential value is calculated between pixel W (2, 2) and pixel W (3, 2), between pixel W (3, 2) and pixel W (4, 4), between pixel W (2, 4) and pixel W (3, 4), and between pixel W (3, 4) and pixel W (4, 4). Each of the acquired differential values is weighted by distance, and a sum of the absolute values of differences is derived. The correlation value in the horizontal direction (correlation value (horizontal)) is expressed by the following Equation (3).

$$\begin{matrix}Correlation value ( horizontal ) = \vert W ( 2 , 2 ) - W ( 3 , 2 ) \vert \times 2 + \\ \vert W ( 3 , 2 ) - W ( 4 , 2 ) \vert \times 2 + \\ \vert W ( 2 , 4 ) - W ( 3 , 4 ) \vert \times 2 + \\ \vert W ( 3 , 4 ) - W ( 4 , 4 ) \vert \times 2\end{matrix} \qquad ( 3 )$$

FIG. 11B is a schematic diagram illustrating pixels used for calculation when deriving correlation of the vertical direction (Y-direction, column direction) of pixel B (3, 3). Each arrow illustrated in FIG. 11B indicates a pair of pixels used for calculating a differential value. That is, when deriving correlation in the vertical direction of pixel B (3, 3), each differential value is calculated between pixel W (2, 2) and pixel W (2, 3), between pixel W (2, 3) and pixel W (2, 4), between pixel W (4, 2) and pixel W (4, 3), and between pixel W (4, 3) and pixel W (4, 4). Each of the acquired differential values is weighted by distance, and a sum of the absolute values of differences is derived. The correlation value in the vertical direction (correlation value (vertical)) is expressed by the following Equation (4).

$$\begin{matrix}Correlation value ( vertical ) = \vert W ( 2 , 2 ) - W ( 2 , 3 ) \vert \times 2 + \\ \vert W ( 2 , 3 ) - W ( 2 , 4 ) \vert \times 2 + \\ \vert W ( 4 , 2 ) - W ( 4 , 3 ) \vert \times 2 + \\ \vert W ( 4 , 3 ) - W ( 4 , 4 ) \vert \times 2\end{matrix} \qquad ( 4 )$$

FIG. 11C is a schematic diagram illustrating pixels used for calculation when deriving correlation of the left-diagonal direction of pixel B (3, 3). Each arrow illustrated in FIG. 11B indicates a pair of pixels used for calculating a differential value. That is, when deriving correlation in the left-diagonal direction of pixel B (3, 3), each differential value is calculated between pixel W (1, 2) and pixel W (2, 3), between pixel W (2, 3) and pixel W (3, 4), and between pixel W (3, 4) and pixel W (4, 5). Further, each differential value is calculated between pixel W (2, 1) and pixel W (3, 2), between pixel W (3, 2) and pixel W (4, 3), and between pixel W (4, 3) and pixel W (5, 4). Each of the acquired differential values is weighted by distance, and a sum of the absolute values of differences is derived. The correlation value in the left-diagonal direction (correlation value (left-diagonal)) is expressed by the following Equation (5).

$$\begin{matrix}Correlation value ( left \text{-} diagonal ) = \vert W ( 1 , 2 ) - W ( 2 , 3 ) \vert + \\ \vert W ( 2 , 3 ) - W ( 3 , 4 ) \vert \times 2 + \\ \vert W ( 3 , 4 ) - W ( 4 , 5 ) \vert + \\ \vert W ( 2 , 1 ) - W ( 3 , 2 ) \vert + \\ \vert W ( 3 , 2 ) - W ( 4 , 3 ) \vert \times 2 + \\ \vert W ( 4 , 3 ) - W ( 5 , 4 ) \vert\end{matrix} \qquad ( 5 )$$

FIG. 11D is a schematic diagram illustrating pixels used for calculation when deriving correlation of the right-diagonal direction of pixel B (3, 3). Each arrow illustrated in FIG. 11B indicates a pair of pixels used for calculating a differential value. That is, when deriving correlation in the right-diagonal direction of pixel B (3, 3), each differential value is calculated between pixel W (1, 4) and pixel W (2, 3), between pixel W (2, 3) and pixel W (3, 2), and between pixel W (3, 2) and pixel W (4, 1). Further, each differential value is calculated between pixel W (2, 5) and pixel W (3, 4), between pixel W (3, 4) and pixel W (4, 3), and between pixel W (4, 3) and pixel W (5, 2). Each of the acquired differential values is weighted by distance, and a sum of the absolute values of differences is derived. The correlation value in the right-diagonal direction (correlation value (right-diagonal)) is expressed by the following Equation (6).

$$\begin{matrix}Correlation value ( right \text{-} diagonal ) = \vert W ( 1 , 4 ) - W ( 2 , 3 ) \vert + \\ \vert W ( 2 , 3 ) - W ( 3 , 2 ) \vert \times 2 + \\ \vert W ( 3 , 2 ) - W ( 4 , 1 ) \vert + \\ \vert W ( 2 , 5 ) - W ( 3 , 4 ) \vert + \\ \vert W ( 3 , 4 ) - W ( 4 , 3 ) \vert \times 2 + \\ \vert W ( 4 , 3 ) - W ( 5 , 2 ) \vert\end{matrix} \qquad ( 6 )$$

Note that the sum of coefficients for respective items of difference is eight when deriving these four correlation values. This is intended to have closer weighting on the places where differences are obtained in calculation and to have the same weighting among four correlation values. Further, the positions of pixels where differences are obtained (arrows) are arranged line-symmetrically with respect to pixel B (3, 3). This is for enhancing the symmetry when deriving correlation to reduce an error in correlation values.

The direction corresponding to the smallest correlation value of the four correlation values acquired in such a way, namely, the correlation value (horizontal), the correlation value (vertical), the correlation value (left-diagonal), and the correlation value (right-diagonal) is the direction with a small gradient, that is, the direction with strong correlation. Accordingly, data on pixels aligned in the direction with strong correlation is used to acquire an interpolation value of a pixel. For example, when correlation in the horizontal direction is strong (the correlation value (horizontal) is the smallest), the interpolation value of pixel B (3, 3) will be the averaged value of data on pixel W (2, 3) and data on pixel W (4, 3).

In such a way, a less gradient direction is derived from data on W pixels near a pixel of interest (pixel B (3, 3) in this example), and interpolation is performed by estimating W data on the pixel of interest from W pixels aligned in the derived direction. By doing so, it is possible to perform an interpolation process in accordance with information on gradient on a single pixel basis, which can improve the resolution.

In step S104, the data Dint after interpolation illustrated in Diagram (c) of FIG. 10 and the data Dcol for color illustrated in Diagram (d) of FIG. 10 are synthesized to generate the RGB data Drgb. The synthesis process in step S104 is performed in a color acquisition unit (not illustrated) of the high accuracy interpolation unit 214. The color acquisition unit acquires a color ratio of a plurality of colors in a predetermined unit region from a color value and a luminance value of the first pixel and acquires, from the acquired color ratio, each color component of the first pixel and the second pixel included in the unit region.

The synthesis of the data Drgb is performed by utilizing the feature that the ratio of local colors is strongly correlated with a luminance and acquiring a ratio of data on a color representing a pixel block of pixels of four rows by four columns (color ratio) and resolution data thereof. Various methods may be employed for the acquisition of a color ratio.

The first method is a method of normalizing and deriving RGB data. This method is expressed by the following Equation (7). Note that the value G is G=(Gr+Gb)/2 in Equation (7).

$$RGB\_ratio = [ \frac{R}{R + G + B} \frac{G}{R + G + B} \frac{B}{R + G + B} ] \qquad ( 7 )$$

The second method is a method of obtaining a ratio of RGB data and the luminance interpolation values iWr, iWg, and iWb. This method is expressed by the following Equation (8).

$$RGB\_ratio = [ \frac{R}{iWr} \frac{Gr + Gb}{iWgr + iWgb} \frac{B}{iWb} ] \qquad ( 8 )$$

The third method is a method of performing a normalizing process from Equation (8). This method is expressed by the following Equation (9). The third method has a higher effect of reducing color noise when separating a luminance value into values for RGB color components compared to the second method. This will be described later.

$$RGB\_ratio = [ \frac{\frac{R}{iWr}}{\frac{R}{iWr} + \frac{Gr + Gb}{iWgr + iWgb} + \frac{B}{iWb}} \frac{\frac{Gr + Gb}{iWgr + iWgb}}{\frac{R}{iWr} + \frac{Gr + Gb}{iWgr + iWgb} + \frac{B}{iWb}} \frac{\frac{B}{iWb}}{\frac{R}{iWr} + \frac{Gr + Gb}{iWgr + iWgb} + \frac{B}{iWb}} ] \qquad ( 9 )$$

In the present embodiment, the third method among the above methods is used.

With a use of data on color ratio RGB ratio and data on a W value or interpolation values iWr, iWgr, iWgb, and iWb acquired in such a way, the RGB value of each pixel can be acquired from the following Equation (10).

RGB=[R_ratio·W G_ratio·W B_ratio·W] (10)

In Equation (10), the values R_ratio, G_ratio, and B_ratio are expressed by the following Equation (11), which correspond to RGB components of the color ratio expressed by Equation (7) to Equation (9).

RGB_ratio=[R_ratio G_ratio B_ratio] (11)

After a series of processes described above, data on a pixel block of pixels of four rows by four columns is extended to the 4×4×3 data Drgb including data on three colors of R, G, and B to respective pixels and is output.

Next, capturing and signal processing in a High Dynamic Range (HDR) mode in the imaging device according to the present embodiment will be described by using FIG. 12 and FIG. 13.

In capturing in the HDR mode, an image with a wide dynamic range is formed by acquiring a plurality of images captured in capturing conditions of different sensitivities and synthesizing the plurality of images. While there are various methods in the methods of changing the sensitivity at capturing, a method of switching the gain and a method of switching the exposure time will be described here as a typical example.

An example of a method of switching the gain may be a method of switching the gain of the column amplifier 32 of the column readout circuit 30. As described above, the gain of the column amplifier 32 of the column readout circuit 30 illustrated in FIG. 3 can be switched into any one of the gains G1, G2, and G3 by switching the capacitance value of the capacitance (capacitors C1a and C1b) connected to the feedback path. A plurality of images captured in capturing conditions of different sensitivities can be acquired by appropriately switching the gains G1, G2, and G3 to amplify a pixel signal at different gains.

The timing of switching the gains G1, G2, and G3 is not particularly limited. For example, by switching the gain on a frame-by-frame basis, it is possible to output images captured in capturing conditions of different sensitivities on a frame-by-frame basis. Alternatively, multiple times of exposure may be performed within one frame to output a signal by changing the gain every time. Alternatively, a signal obtained by one time of exposure may be amplified for multiple times at different gains to output the amplified signal.

The exposure time can be switched by controlling the accumulation time of signal charges in the photoelectric converter PD. As illustrated using FIG. 6, with an appropriate setting of the time from a reset operation to a readout operation, the accumulation time of charges in the photoelectric converter PD can be changed.

The timing of switching the exposure time is not particularly limited. For example, images captured in capturing conditions of different sensitivities can be output on a frame-by-frame basis by switching the accumulation time on a frame-by-frame basis. Alternatively, multiple times of exposure may be performed within one frame to output a signal by changing the accumulation time every time.

Note that the scheme of switching the sensitivity is not limited to the above, and other schemes may be applied. For example, the gain of a readout circuit within a pixel can be changed by switching the floating diffusion capacitor. Further, the sensitivity may be switched by using any combination of the schemes described above.

Next, a process in the signal processing unit 200 of an image captured in the HDR mode in the imaging element 100 will be described.

When captured in the HDR mode, a plurality of images captured in the capturing condition of different sensitivities are output from the imaging element 100 to the signal processing unit 200. An interpolation process is performed on the plurality of images input to the signal processing unit 200 in the same manner as the process from step S101 to step S103 described above, and a luminance value (interpolation value) iW in a color pixel is acquired.

FIG. 12 is a graph illustrating a relationship of the color value and the luminance value (interpolation value) iW in a color pixel and the incident light amount. In FIG. 12, each solid line represents a color value Col_{H} and a luminance value iW_{H} when captured in a high sensitivity mode, and each dotted line represents a color value Col_{L} and a luminance value iW_{L} when captured in a low sensitivity mode. Note that the high sensitivity mode as used herein corresponds to capturing in a condition with a high gain when the sensitivity is set by switching the gain and corresponds to capturing in a condition with a long accumulation time when the sensitivity is set by switching the exposure time. Further, the low sensitivity mode as used herein corresponds to capturing in a condition with a low gain when the sensitivity is set by switching the gain and corresponds to capturing in a condition with a short accumulation time when the sensitivity is set by switching the exposure time.

The expression “saturation” represented in the vertical axis indicates a value corresponding to a saturation level of the pixel 12. As described above, since the W pixel has a higher sensitivity than the RGB pixels, a light amount at which the luminance value iW reaches the saturation level is less than a light amount at which the color value Col reaches the saturation level under the same capturing condition. For the purpose of illustration here, a range of the light amount up to a light amount Lx1 at which the luminance value iW_{H} is saturated is defined as “range 1”, a range of the light amount from the light amount Lx1 to a light amount Lx2 at which the color value Col_{H} is saturated is defined as “range 2”, and a range of the light amount from the light amount Lx2 to a light amount Lx3 at which the color value Col_{L} is saturated is defined as “range 3”.

When the incident light amount is in the range 1, acquisition of a color ratio in the color pixel is performed in accordance with the color value Col_{H} in the color pixel of interest and the luminance value iW_{H} that is an interpolation value acquired from the surrounding W pixels of the color pixel of interest. Further, when the incident light amount is in the range 3, acquisition of a color ratio in the color pixel is performed in accordance with the color value Col_{L} in the color pixel of interest and the luminance value iW_{L} that is an interpolation value acquired from the surrounding W pixels of the color pixel of interest.

On the other hand, when the incident light amount is in the range 2, the luminance value iW_{H} is saturated, and thus no acquisition of a color ratio in the color pixel can be performed in accordance with the color value Col_{H} and the luminance value iW_{H}. Accordingly, when the incident light amount is in the range 2, acquisition of a color ratio in the color pixel is performed in accordance with the color value Col_{H} in the color pixel of interest and the luminance value iW_{L} that is an interpolation value acquired from the surrounding W pixels of the color pixel of interest.

That is, the color acquisition unit acquires a color ratio by using a color value of the first pixel acquired in the first capturing condition and a luminance value of the first pixel based on a signal of the second pixel acquired in the second capturing condition having a lower sensitivity than the first capturing condition. This acquisition is performed when the luminance value of the first pixel based on the signal of the second pixel acquired in the first capturing condition is greater than or equal to a level at which the second pixel is saturated. Further, the color acquisition unit acquires a color ratio by using the color value of the first pixel acquired in the first capturing condition and the luminance value of the first pixel based on the signal of the second pixel acquired in the first capturing condition. This acquisition is performed when the luminance value of the first pixel based on the signal of the second pixel acquired in the first capturing condition is less than a level at which the second pixel is saturated.

For example, in the range 2 in FIG. 12, when the color value Col_{L} is P1, the color value Col_{H} is P2. The relationship of the color value Col_{L} and the color value Col_{H} is expressed by a gain ratio N between the low sensitivity mode and the high sensitivity mode. On the other hand, when the luminance value iW_{L} is P3, the luminance value iW_{H} is saturated in the range 2 and thus is constant value P4. Accordingly, value P5 of the luminance value iW_{H} which would be obtained if no saturation occurred (luminance value iW_{H}′) is estimated from the gain ratio N between the low sensitivity mode and the high sensitivity mode and used for acquisition of a color ratio. Acquisition of a color ratio in this case (Col/iW) is expressed by the following Equation (12).

Col/iW=P2/(P3×N) (12)

Note that it is possible to use the color value Col_{L} and the luminance value iW_{L} in acquisition of a color ratio when the incident light amount is in the range 2. However, acquisition of a color ratio by using the color value Col_{H} as described above allows an image with a better S/N ratio to be acquired.

In particular, in a synthesis process in the RGBW-12 arrangement, acquisition will be performed by using the same color ratio in 16 pixels, as illustrated in FIG. 10. That is, a worse S/N ratio of a color value acquired from the color pixel causes a worse S/N ratio in Equation (11) and causes occurrence of color noise in color calculation in Equation (10). Moreover, a large area of 16 pixels will be affected.

It is therefore preferable to use an acquired value having a good S/N ratio acquired from Equation (12) in the synthesis process when the incident light amount is in the range 2.

The acquisition process of a color ratio in a color pixel described above can be implemented in accordance with the flowchart illustrated in FIG. 13, for example.

First, in step S201, the data separation process in step S102 described above is performed on data of a plurality of images captured in capturing conditions of different sensitivities, and values of color pixel (color values Col_{H} and Col_{L}) are acquired.

Next, in step S202, the interpolation process in step S103 described above is performed on data of the plurality of images captured in capturing conditions of different sensitivities, and luminance values of color pixel (luminance values iW_{H} and iW_{L}) are acquired.

Next, in step S203, it is determined whether or not the luminance value iW_{H} is saturated. If the luminance value iW_{H} is less than or equal to a saturation level of the pixel (step S203, “No”), it is determined that the luminance value iW_{H} indicates a right value, and the color value Col_{H} and the luminance value iW_{H} are used for acquisition of a color ratio (step S204). If the luminance value iW_{H} is greater than the saturation level of the pixel (step S203, “Yes”), it is determined that the luminance value iW_{H} is saturated, and the color value Col_{H} and the luminance value iW_{L} are used for acquisition of a color ratio (step S205).

Next, in step S206, the synthesis process in step S104 described above is performed, and RGB data of each pixel is acquired by using data of the color ratio acquired in step S204 or step S205.

By performing the process described above on an image captured in the HDR mode in such a way, it is possible to acquire a high quality image having a wide dynamic range and a high color reproducibility.

As described above, according to the present embodiment, an imaging device that can acquire a high quality image having a wide dynamic range and a high color reproducibility can be realized.

### Second Embodiment

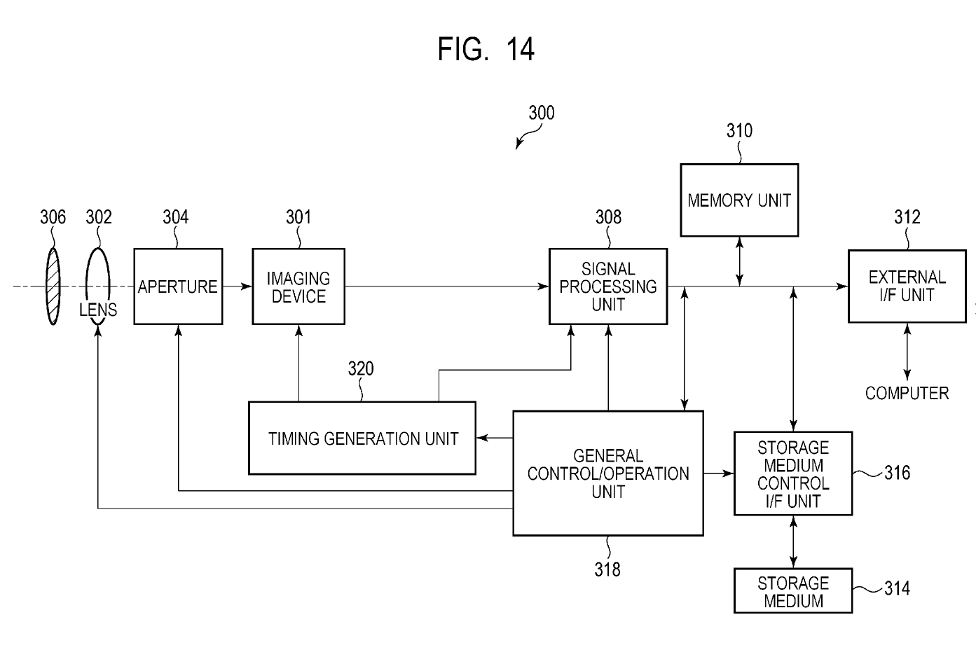

An imaging system according to a second embodiment of the present invention will be described with reference to FIG. 14. FIG. 14 is a block diagram illustrating a general configuration of an imaging system according to the present embodiment.

An imaging system 300 of the present embodiment includes an imaging device to which the configuration described in the above first embodiment is applied. A specific example of the imaging system 300 may be a digital still camera, a digital camcorder, a surveillance camera, or the like. FIG. 14 illustrates a configuration example of a digital still camera to which an imaging device of the first embodiments is applied.

The imaging system 300 illustrated as an example in FIG. 14 includes the imaging device 301, a lens 302 that captures an optical image of an object onto the imaging device 301, an aperture 304 for changing a light amount passing through the lens 302, and a barrier 306 for protecting the lens 302. The lens 302 and the aperture 304 form an optical system that converges a light onto the imaging device 301.

The imaging system 300 further includes a signal processing unit 308 that processes an output signal output from the imaging device 301. The signal processing unit 308 performs an operation of signal processing for performing various correction and compression on an input signal, if necessary, to output the signal. For example, the signal processing unit 308 performs on an input signal, predetermined image processing such as a conversion process of converting pixel output signals of RGB to Y, Cb, Cr color space, gamma correction, or the like. Further, the signal processing unit 308 may have some or all of the functions of the signal processing unit 200 in the imaging device described in the first embodiment.

The imaging system 300 further includes a memory unit 310 for temporarily storing image data therein and an external interface unit (external I/F unit) 312 for communicating with an external computer or the like. The imaging system 300 further includes a storage medium 314 such as a semiconductor memory used for performing storage or readout of imaging data and a storage medium control interface unit (storage medium control I/F unit) 316 used for performing storage or readout on the storage medium 314. Note that the storage medium 314 may be embedded in the imaging system 300 or may be removable.

The imaging system 300 further includes a general control/operation unit 318 that performs various computation and controls the entire digital still camera and a timing generation unit 320 that outputs various timing signals to the imaging device 301 and the signal processing unit 308. The timing signal or the like may be externally input, and the imaging system 300 may include at least the imaging device 301 and the signal processing unit 308 that processes an output signal output from the imaging device 301. The general control/operation unit 318 and the timing generation unit 320 may be configured to perform some or all of control functions of the imaging device 301.

The imaging device 301 outputs an imaging signal to the signal processing unit 308. The signal processing unit 308 performs predetermined signal processing on an imaging signal output from the imaging device 301 and outputs image data. Further, the signal processing unit 308 generates an image by using the imaging signals. The image generated in the signal processing unit 308 is stored in the storage medium 314, for example. Further, the image generated in the signal processing unit 308 is displayed as a moving image or a static image on a monitor formed of a liquid crystal display or the like. An image stored in the storage medium 314 can be hard-copied by a printer or the like.

By forming an imaging system using the imaging device of the first embodiment, it is possible to realize an imaging system capable of acquiring a higher quality image.

### Third Embodiment

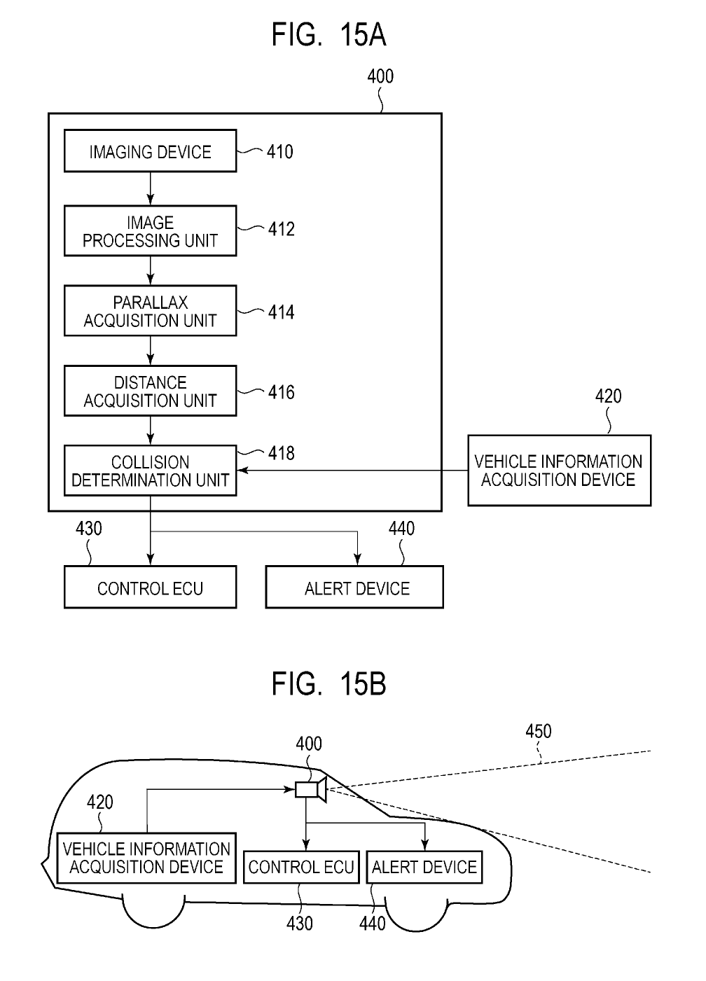

An imaging system and a movable object according to a third embodiment of the present invention will be described by using FIG. 15A and FIG. 15B. FIG. 15A is a diagram illustrating a configuration of an imaging system according to the present embodiment. FIG. 15B is a diagram illustrating a configuration example of a movable object according to the present embodiment.

FIG. 15A illustrates an example of an imaging system 400 related to an on-vehicle camera. The imaging system 400 includes an imaging device 410. The imaging device 410 is any of the imaging devices described in the first embodiment. The imaging system 400 includes an image processing unit 412 that performs image processing on a plurality of image data acquired by the imaging device 410 and a parallax acquisition unit 414 that acquires a parallax (a phase difference of parallax images) from the plurality of image data acquired by the imaging device 410. The image processing unit 412 may have some or all of the functions of the signal processing unit 200 in the imaging device described in the first embodiment. Further, the imaging system 400 includes a distance acquisition unit 416 that acquires a distance to an object based on the acquired parallax and a collision determination unit 418 that determines whether or not there is a collision possibility based on the acquired distance. Here, the parallax acquisition unit 414 and the distance acquisition unit 416 are an example of a distance information acquisition unit that acquires distance information on the distance to an object. That is, the distance information is information on a parallax, a defocus amount, a distance to an object, or the like. The collision determination unit 418 may use any of the distance information to determine the collision possibility. The distance information acquisition unit may be implemented by dedicatedly designed hardware or may be implemented by a software module. Further, the distance information acquisition unit may be implemented by a Field Programmable Gate Array (FPGA), an Application Specific Integrated Circuit (ASIC), or the like or may be implemented by a combination thereof.

The imaging system 400 is connected to a vehicle information acquisition device 420 and can acquire vehicle information such as a vehicle speed, a yaw rate, a steering angle, or the like. Further, the imaging system 400 is connected to a control ECU 430, which is a control device that outputs a control signal for causing a vehicle to generate braking force based on a determination result by the collision determination unit 418. That is, the control ECU 430 is an example of a movable object control unit for controlling a movable object based on the distance information. Further, the imaging system 400 is also connected to an alert device 440 that issues an alert to the driver based on a determination result by the collision determination unit 418. For example, when the collision probability is high as the determination result of the collision determination unit 418, the control ECU 430 performs vehicle control to avoid a collision or reduce damage by applying a brake, pushing back an accelerator, suppressing engine power, or the like. The alert device 440 alerts a user by sounding an alert such as a sound, displaying alert information on a display of a car navigation system or the like, providing vibration to a seat belt or a steering wheel, or the like.

In the present embodiment, an area around a vehicle, for example, a front area or a rear area is captured by using the imaging system 400. FIG. 15B illustrates the imaging system 400 in a case of capturing a front area of a vehicle (a capturing region 450). The vehicle information acquisition device 420 transmits instructions to cause the imaging system 400 to operate and perform capturing. The use of the imaging device of each embodiment described above as the imaging device 410 enables the imaging system 400 of the present embodiment to further improve the ranging accuracy.

Although an example of control for avoiding a collision to another vehicle has been described in the description above, it is applicable to automatic driving control for following another vehicle, automatic driving control for not going out of a traffic lane, or the like. Furthermore, the imaging system is not limited to a vehicle such as the subject vehicle and can be applied to a movable object (moving apparatus) such as a ship, an airplane, or an industrial robot, for example. In addition, the imaging system can be widely applied to a device which utilizes object recognition, such as an intelligent transportation system (ITS), without being limited to movable objects.

### Modified Embodiments

The present invention is not limited to the embodiments described above, and various modifications are possible.

For example, an example in which a part of the configuration of any of the embodiments is added to another embodiment or an example in which a part of the configuration of any of the embodiments is replaced with a part of the configuration of another embodiment is one of the embodiments of the present invention.

Further, although the case of forming a high dynamic range image by synthesizing a plurality of images captured in capturing condition of different sensitivities has been described as an example in the above embodiments, it is not necessarily required to form a high dynamic range image. For example, capturing in the low sensitivity mode may be used only in acquisition of the luminance value iW_{L} of the color pixel. This can improve the S/N ratio of an image captured in the high sensitivity mode.

Further, the circuit configuration of the pixel 12 or the column readout circuit 30 is not limited to that illustrated in FIG. 3 and can be changed where appropriate. For example, each of the pixels 12 may include a plurality of photoelectric converters PD.

Further, although the case where the RGBW12 arrangement is employed as a color filter arrangement has been described in the above embodiments, it is not necessarily required to be the color filter of the RGBW12 arrangement. For example, a color filter of RGBW arrangement having a different ratio of W pixels, for example, a color filter of RGBW-8 arrangement may be employed. Alternatively, it may be a color filter of a CMYW arrangement including a C pixel having a cyan CF, an M pixel having a magenta CF, a Y pixel having a yellow CF, and the W pixels, for example.

Further, although an imaging element that performs so-called rolling shutter drive in which the accumulation time of pixels on each row is started sequentially on a row-by-row basis has been described as an example in the above embodiment, the present invention is not always limited to the imaging element that performs the rolling shutter drive. For example, the present invention can be applied to an imaging element that performs so-called global electronic shutter drive with the same accumulation time for pixels on respective rows.

Further, the imaging systems illustrated in the second and third embodiments are examples of an imaging system to which the imaging device of the present invention may be applied, the imaging system to which the imaging device of the present invention can be applied is not limited to the configuration illustrated in FIG. 14 and FIG. 15A.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-236393, filed Dec. 8, 2017 which is hereby incorporated by reference herein in its entirety.

What is claimed is:

1. An imaging device comprising:
an imaging element including a plurality of pixels that includes a plurality of first pixels, each of which outputs a signal including color information on any of a plurality of colors, and a plurality of second pixels having a higher sensitivity than the first pixels; and
a signal processing unit that processes signals output from the imaging element,
wherein the signal processing unit includes
a luminance value acquisition unit that acquires luminance values of the first pixels based on signals output from the second pixels, and
a color acquisition unit that acquires color ratios of the plurality of colors in a predetermined unit region from color values and the luminance values of the first pixels and acquires, from the acquired color ratios, color components of each of the first pixels and each of the second pixels included in the unit region, and
wherein the color acquisition unit acquires each of the color ratios by using color values in the first pixels acquired in a first capturing condition and luminance values in the first pixels based on signals of the second pixels acquired in a second capturing condition of a lower sensitivity than the first capturing condition.

2. The imaging device according to claim 1, wherein when a luminance value of the first pixels based on signals of the second pixels acquired in the first capturing condition is greater than or equal to a level at which the second pixels are saturated, the color acquisition unit acquires each of the color ratios by using the color value in the first pixels acquired in the first capturing condition and the luminance value in the first pixels based on signals of the second pixels acquired in the second capturing condition.

3. The imaging device according to claim 2, wherein when a luminance value of the first pixels based on signals of the second pixels acquired in the first capturing condition is less than a level at which the second pixels are saturated, the color acquisition unit acquires the color ratio by using the color value in the first pixels acquired in the first capturing condition and the luminance value in the first pixels based on signals of the second pixels acquired in the first capturing condition.

4. The imaging device according to claim 1, wherein the signal processing unit synthesizes a first image based on signals acquired in the first capturing condition and a second image based on signals acquired in the second capturing condition to generate a third image.

5. The imaging device according to claim 3, wherein the signal processing unit synthesizes a first image based on signals acquired in the first capturing condition and a second image based on signals acquired in the second capturing condition to generate a third image.

6. The imaging device according to claim 1, wherein the first capturing condition and the second capturing condition are different in a gain applied to signals output from the plurality of pixels.

7. The imaging device according to claim 5, wherein the first capturing condition and the second capturing condition are different in a gain applied to signals output from the plurality of pixels.

8. The imaging device according to claim 1, wherein the first capturing condition and the second capturing condition are different in a length of exposure time for the plurality of pixels.

9. The imaging device according to claim 5, wherein the first capturing condition and the second capturing condition are different in a length of exposure time for the plurality of pixels.

10. The imaging device according to claim 1, wherein the luminance value acquisition unit acquires the luminance value in the first pixels in accordance with a direction in which luminance acquired from luminance values of the second pixels changes.

11. The imaging device according to claim 5, wherein the luminance acquisition unit acquires the luminance value in the first pixels in accordance with a direction in which luminance acquired from luminance values of the second pixels changes.

12. The imaging device according to claim 1, wherein the color acquisition unit acquires the color component in accordance with the color ratios on which a normalizing process is performed.

13. The imaging device according to claim 1, wherein each of the plurality of first pixels is surrounded by the second pixels.

14. The imaging device according to claim 1, wherein, in the plurality of pixels, the number of the second pixels is twice or more the number of the first pixels.

15. The imaging device according to claim 1, wherein the plurality of first pixels are consist of at least one R pixel, at least one G pixel, and at least one B pixel.

16. The imaging device according to claim 1, wherein the plurality of first pixels are consist of at least one C pixel, at least one M pixel, and at least one Y pixel.

17. The imaging device according to claim 1, wherein the plurality of second pixels are consist of W pixels.

18. A signal processing device that processes signals output from an imaging element including a plurality of pixels that include a plurality of first pixels, each of which outputs a signal including color information on any of a plurality of colors, and a plurality of second pixels having a higher sensitivity than the first pixels, the signal processing device comprising:
a luminance value acquisition unit that acquires luminance values of the first pixels based on signals output from the second pixels; and
a color acquisition unit that acquires color ratios of the plurality of colors in a predetermined unit region from color values and the luminance values of the first pixels and acquires, from the acquired color ratios, color components of each of the first pixels and each of the second pixels included in the unit region,
wherein the color acquisition unit acquires each of the color ratios by using color values in the first pixels acquired in a first capturing condition and luminance values in the first pixels based on signals of the second pixels acquired in a second capturing condition of a lower sensitivity than the first capturing condition.

19. An imaging system comprising:
an imaging device including an imaging element including a plurality of pixels that include plurality of first pixels, each of which outputs a signal including color information on any of a plurality of colors, and a plurality of second pixels having a higher sensitivity than the first pixels; and
a signal processing unit that processes signals output from the imaging device,
wherein the signal processing unit includes
a luminance value acquisition unit that acquires luminance values of the first pixels based on signals output from the second pixels, and
a color acquisition unit that acquires color ratios of the plurality of colors in a predetermined unit region from color values and the luminance values of the first pixels and acquires, from the acquired color ratios, color components of each of the first pixels and each of the second pixels included in the unit region, and
wherein the color acquisition unit acquires each of the color ratios by using color values in the first pixels acquired in a first capturing condition and luminance values in the first pixels based on signals of the second pixels acquired in a second capturing condition of a lower sensitivity than the first capturing condition.

20. A movable object comprising:
the imaging device according to claim 1;
a distance information acquisition unit that acquires distance information on a distance to an object, from a parallax image based on signals output from the pixels of the imaging device; and
a control unit that controls the movable object based on the distance information.
